(19) United States
(12) Patent Application Publication
(10) Pub. No.: US 2022/0065560 A1
(43) Pub. Date: Mar. 3, 2022

(54) WELDING METHOD OF CONNECTOR AND CONNECTION TUBE, CONNECTION STRUCTURE AND HEAT EXCHANGER

(71) Applicant: SANHUA (HANGZHOU) MICRO CHANNEL HEAT EXCHANGER CO., LTD., HANGZHOU, ZHEJIANG (CN)

(72) Inventors: Yuzhang LIU, HANGZHOU, ZHEJIANG (CN); Han ZHOU, HANGZHOU, ZHEJIANG (CN); Yuke ZUO, HANGZHOU, ZHEJIANG (CN); Chuanting WANG, HANGZHOU, ZHEJIANG (CN)

(21) Appl. No.: 17/276,019

(22) PCT Filed: Sep. 12, 2019
(86) PCT No.: PCT/CN2019/105567

§ 371 Date: Mar. 12, 2021

(30) Foreign Application Priority Data
Sep. 14, 2018 (CN) 201811076567.1
Sep. 14, 2018 (CN) 201821512267.9

(51) Int. Cl. F28F 9/02; F28F 19/06; B23K 1/00; B23K 35/28; C23C 4/08

(52) U.S. Cl. CPC F28F 9/0256; F28F 19/06; B23K 1/0012; B23K 2101/14; C23C 4/08; F28F 2275/045; B23K 35/288

(57) ABSTRACT

A welding method for a connector and a connection tube of a heat exchanger are proposed. The method includes: forming a diffusion layer on a surface of the connector, a corrosion potential of the diffusion layer being less than a corrosion potential of the connector; inserting a connection tube into the connector; brazing the connection tube to the connector by a brazing filler metal, a corrosion potential of a weld metal formed after brazing of the brazing filler metal being higher than the corrosion potential of the connector and less than a corrosion potential of the connection tube.

### CROSS-REFERENCE TO RELATED APPLICATIONS

The present application is a U.S. national phase entry under 35 USC § 371 of the International Patent Application No. PCT/CN2019/105567, filed on Sep. 12, 2019, which claims the benefit of and priority to Chinese Applications No. 201811076567.1 and 201821512267.9, filed on Sep. 14, 2018, the entire disclosures of which are incorporated herein by reference.

### FIELD

The present disclosure relates to a technical field of heat exchange, and more particularly to a welding method of a connector and a connection tube of a heat exchanger, a connection structure of a heat exchanger, and a heat exchanger.

### BACKGROUND

Connectors (such as copper aluminum brazed connectors) are often used to be connected to pipelines in refrigeration and heating ventilation air conditioning systems as well as heat exchangers in a related art. Such connectors are usually brazed by using a brazing filler metal in combination with a fluoroaluminate brazing flux, but the connectors are prone to corrosion and leakage in a relatively short time.

In order to avoid corrosion, an outer side of the copper aluminum connector usually needs to be wrapped with a heat shrinkable sleeve, an adhesive tape, a mastic or to be coated with a protective layer for corrosion protection. Since the residual brazing flux on a surface of the connector is not easy to be cleaned thoroughly, the protection effect of the heat shrinkable tube will be diminished, and some copper aluminum connectors will still have corrosion and leakage during the subsequent use.

### SUMMARY

According to a first aspect of embodiments of the present disclosure, a welding method of a connector and a connection tube of a heat exchanger is proposed, and includes: forming a diffusion layer on a surface of the connector, a corrosion potential of the diffusion layer being less than a corrosion potential of the connector; inserting a connection tube into the connector; brazing the connection tube to the connector by a brazing filler metal, a corrosion potential of a weld metal formed after brazing of the brazing filler metal being higher than the corrosion potential of the connector and less than a corrosion potential of the connection tube.

According to a second aspect of embodiments of the present disclosure, a connection structure of a heat exchanger is proposed, and includes: a connector, a diffusion layer being formed on a surface of the connector; and a connection tube inserted into the connector and brazed with the connector through a brazing filler metal. A corrosion potential of the diffusion layer, a corrosion potential of the connector, a corrosion potential of a weld metal formed after brazing of the brazing filler metal, and a corrosion potential of the connection tube increase in sequence.

According to a third aspect of embodiments of the present disclosure, a heat exchanger is proposed, and includes: a header; and a connection structure of a heat exchanger. The connection structure of the heat exchanger includes: a connector, a diffusion layer being formed on a surface of the connector; and a connection tube inserted into the connector and brazed with the connector through a brazing filler metal. A corrosion potential of the diffusion layer, a corrosion potential of the connector, a corrosion potential of a weld metal formed after brazing of the brazing filler metal, and a corrosion potential of the connection tube increase in sequence. The connector is connected to the header, and the connection tube is communicated with the header through the connector.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

The above and/or additional aspects and advantages of the present disclosure will become apparent and readily appreciated from the following descriptions of embodiments made with reference to the drawings.

FIG. 1 is a schematic view of a heat exchanger according to an embodiment of the present disclosure.

FIG. 2 is a schematic view of a connector of a connection structure of a heat exchange tube according to an embodiment of the present disclosure.

FIG. 3 is a flow chart of a welding method of a connection tube and a connector of a heat exchanger according to an embodiment of the present disclosure.

### DETAILED DESCRIPTION

Embodiments of the present disclosure are further described. Examples of the embodiments are illustrated in the accompanying drawings. Same or similar reference signs represent the same or similar components or components that have the same or similar functions from beginning to end. The embodiments described below with reference to the accompanying drawings are exemplary, are merely used to explain the present disclosure, and cannot be construed as a limitation to the present disclosure.

In the specification of the present disclosure, it is to be understood that, the indicated orientation or position relationship is based on the orientation or position relationship illustrated in the drawings, which is only for convenience of descriptions or for simplifying descriptions of the present disclosure, and does not indicate or imply that the device or element referred to must have a particular orientation or be constructed and operated in a specific orientation, and hence cannot be construed as limitation to the present disclosure.

In the present disclosure, it should be noted that, unless specified otherwise, terms “mounted,” “coupled,” and “connected,” should be understood broadly, for example, may be fixed connections, detachable connections, or integral connections; may also be mechanical or electrical connections; may also be direct connections or indirect connections via intervening structures; may also be inner communications of two elements, which may be understood by those skilled in the related art according to specific situations.

A connection structure of a heat exchanger according to embodiments of the present disclosure will be described below with reference to the accompanying drawings.

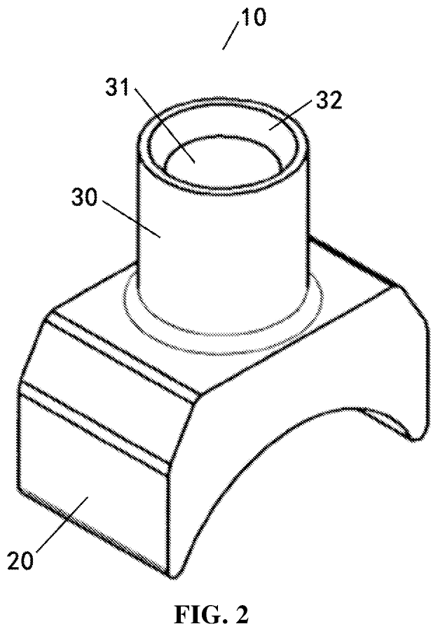

As illustrated in FIG. 2, the connection structure of the heat exchanger according to the embodiment of the present disclosure includes a connector 10 and a connection tube 40.

A diffusion layer is formed on a surface of the connector 10. The connection tube 40 is inserted into the connector 10 and is brazed with the connector 10 through a brazing filler metal.

A corrosion potential of the diffusion layer, a corrosion potential of the connector 10, a corrosion potential of a weld metal formed after brazing of the brazing filler metal, and a corrosion potential of the connection tube 40 increase in sequence.

In other words, the corrosion potential of the diffusion layer<the corrosion potential of the connector 10<the corrosion potential of the weld metal formed after brazing of the brazing filler metal<the corrosion potential of the connection tube 40.

A welding method of the connector and the connection tube of the heat exchanger according to the embodiments of the present disclosure is described below with reference to the accompanying drawings.

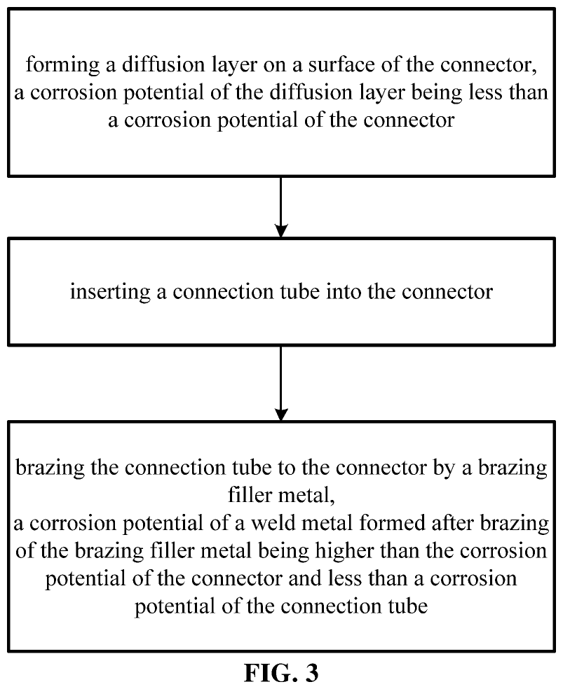

As illustrated in FIG. 3, the welding method of the connector and the connection tube of the heat exchanger according to the embodiments of the present disclosure includes following steps. A diffusion layer is formed on a surface of a connector 10, and a corrosion potential of the diffusion layer is less than a corrosion potential of the connector 10.

A connection tube 40 is inserted into the connector 10.

The connection tube 40 is brazed to the connector 10 by a brazing filler metal, a corrosion potential of a weld metal formed after brazing of the brazing filler metal is higher than the corrosion potential of the connector 10 and less than a corrosion potential of the connection tube 40.

In the connection structure of the heat exchanger and the welding method of the connector and the connection tube of the heat exchanger according to the embodiments of the present disclosure, the diffusion layer is formed on the surface of the connector 10, and the corrosion potentials of various parts meet a following relationship: the corrosion potential of the diffusion layer<the corrosion potential of the connector 10<the corrosion potential of the weld metal formed after brazing of the brazing filler metal<the corrosion potential of the connection tube 40.

Thus, through such design of a potential gradient, a first corrosion of the weld and a premature pitting corrosion of the connector 10 in a corrosive environment may be avoided, and a first corrosion of the weld metal and resulted corrosion products, which are accumulated and expanded in the weld to cause cracks at an uncorroded portion of the connector 10, may be further avoided, so as to greatly improve a corrosion-resistant life.

In addition, there is no need to wrap a heat shrinkable sleeve, an adhesive tape, a mastic or coating a protective layer for a corrosion protection, which saves pre-operations of polishing and cleaning the surface of connector 10, so as to greatly reduce the production process, thus effectively improving the production efficiency and reducing the production cost.

Therefore, the connection structure of the heat exchanger and the welding method of the connector and the connection tube of the heat exchanger according to the embodiments of the present disclosure have advantages of a good anti-corrosion effect, a high production efficiency and a low production cost.

It may be understood by those skilled in the related art that the connection structure of the heat exchanger and the welding method of the connector and the connection tube of the heat exchanger according to the embodiments of the present disclosure may also be applied to occasions without tube members, such as a copper aluminum transition connector (a copper aluminum transition bar), and may be applied to occasions of electric conduction. In addition, the heat shrinkable sleeve, the adhesive tape, the mastic may be wrapped or the protective layer may be coated to further improve the service life and meet use requirements in a highly corrosive environment.

In some specific embodiments of the present disclosure, the diffusion layer is formed on at least one surface of an inner peripheral surface and an outer peripheral surface of the connector 10, so as to avoid corrosion at a corresponding part of the connector 10, thereby being applicable to different occasions. For example, when applied to a water system, the diffusion layer is formed on the inner peripheral surface of the connector 10 accordingly.

In some specific examples of the present disclosure, as illustrated in FIG. 2, the connector 10 includes a header connection couple 20 and a connector body 30.

The header connection couple 20 is configured to be connected with a header 50 of the heat exchanger. For example, the header connection couple 20 is configured have an arc surface adapted to a shape of a peripheral surface of the header 50. The connector body 30 is arranged to the header connection couple 20, and has a connection hole 31. The connection hole 31 runs through the connector body 30 and the header connection couple 20 along an axial direction of the connector body 30.

The diffusion layer is formed on at least one surface of an inner peripheral surface and an outer peripheral surface of the connector body 30, the connection tube 40 is inserted into the connection hole 31, and an outer peripheral surface of the connection tube 40 is brazed with the inner peripheral surface of the connector body 30 through the brazing filler metal so as to achieve the connection between the connection tube 40 and the connector 10. The connection tube 40 may be communicated with the header 50 through the connector 10, and the diffusion layer is formed on the outer peripheral surface of the connector body 30 or the inner peripheral surface near a brazing surface of the connector body 30, such that the brazing portion has a relatively high corrosion resistance.

Furthermore, as illustrated in FIG. 2, an end face of an end of the connector body 30 away from the header connection couple 20 is provided with a slope 32, and the slope 32 gradually inclines towards the header connection couple 20 from outside to inside along a radial direction of the connector body 30. Thus, on one hand, the connection tube 40 may be easily inserted into the connection hole 31, and on the other hand, the stability after welding may be improved.

In some specific embodiments of the present disclosure, a coating is formed on the surface of the connector 10 by means of electric arc spraying, chemical immersion plating or coating, and then the coating and the connector 10 are heated to form the diffusion layer.

In some embodiments, a maximum temperature of the heating is 585-615° C., a heating time at the maximum temperature is 1.5 min-30 min, and the connector 10 may be put into a furnace together with a core of the heat exchanger to obtain the diffusion layer.

In some embodiments, the maximum temperature of the heating is 330-410° C., the heating time at the maximum temperature is 1 h-3 h, and the connector 10 is configured to have a separate diffusion treatment.

In some embodiments of the present disclosure, the connector 10 is an aluminum connector or an aluminum alloy connector, the connection tube 40 is a copper tube, the diffusion layer is formed through diffusion of the coating formed on the surface of the connector 10, and the coating contains zinc which comes from a pure zinc, a zinc-contained alloy or a zinc-contained compound.

A mass of zinc per unit area of the coating is 0.2 g/m²-60 g/m², and a mass concentration of zinc of the diffusion layer is 0.5%-20%.

Further, a thickness of the diffusion layer is 10 μm-200 μm.

The above process parameter ranges of the processing are intended to ensure that the thickness of the diffusion layer and the zinc concentration of the surface layer are within the appropriate ranges. Thus, on one hand, the uniform diffusion of the coating and the protection time may be ensured, so as to effectively protect the weld; on the other hand, the sacrificing speed of the diffusion layer may be slowed down, so as to prolong the protection time.

In some specific examples of the present disclosure, the brazing filler metal contains a Al—Si base, a Al—Cu—Si base, a Al—Cu—Si—Zn base or a Al—Cu—Si—Ni base, and the corrosion potential of the weld metal formed by the brazing filler metal is between the corrosion potential of the copper and the corrosion potential of the aluminum alloy, so as to prevent the weld from being corroded firstly, and the dissolution of the copper base material to the weld during the brazing further improves the corrosion potential of the weld metal, thus ensuring the anti-corrosion effect.

Following examples are taken to describe the welding method of the connector and the connection tube of the heat exchanger according to the embodiments of the present disclosure.

In some embodiments, the connector 10 is made of aluminum alloy. Pure zinc is sprayed on the outer peripheral surface of the connector body 30 by means of electric arc spraying. A mass of sprayed zinc per unit area is about 1-20 g/m². The connector 10 after the zinc spraying is placed in a nitrogen-protected heating furnace to be heated (the connector 10 may be put into the furnace together with the core of the heat exchanger or may be put into the furnace separately). The maximum temperature of the heating is about 585-615° C., and the heating time at the maximum temperature is about 1.5-10 min, which are determined by the thickness of the material. The connector 10 is cooled down after the heating. It is tested that the thickness of the diffusion layer obtained after the heating is about 10-200 μm, and the mass concentration of zinc of the diffusion layer is about 1-10%.

The connection tube 40 made of copper is placed into the connection hole 31 of the above connector 10, the Al—Si based brazing filler metal is selected, the oxygen acetylene flame is adopted for heating, the brazing is performed by means of the fluoroaluminate brazing flux, and the product is obtained after the brazing.

Two ends of the above product are sealed, and then a salt spray test of an acid simulated seawater circulation (ASTM G85-A3 standard) is carried out. After 1000 hours of the salt spray test, there is no external corrosion and leakage.

In some other embodiments, the connector 10 is made of aluminum alloy. Pure zinc is sprayed on the outer peripheral surface of the connector body 30 by means of electric arc spraying. A mass of sprayed zinc per unit area is about 1-20 g/m². The connector 10 after the zinc spraying is placed in a nitrogen-protected heating furnace to be heated (the connector 10 may be put into the furnace together with the core of the heat exchanger or may be put into the furnace separately). The maximum temperature of the heating is about 330-410° C., and the heating time at the maximum temperature is about 1-3 h. The connector 10 is cooled down after the heating. It is tested that the thickness of the diffusion layer obtained after the heating is about 20-200 μm, and the mass concentration of zinc of the diffusion layer is about 1-5%.

The connection tube 40 made of copper is placed into the connection hole 31 of the connector 10, the Al—Cu—Si based brazing filler metal is selected, the oxygen acetylene flame is adopted for heating, the brazing is performed by means of the fluoroaluminate brazing flux, and the product is obtained after the brazing.

Two ends of the above product are sealed, and then a salt spray test of an acid simulated seawater circulation (ASTM G85-A3 standard) is carried out. After 1000 hours of the salt spray test, there is no external corrosion and leakage.

In some other embodiments, the connector 10 is made of aluminum alloy. The outer peripheral surface of the connector body 30 is immersed with zinc by means of chemical zinc immersion. A mass of immersed zinc per unit area is about 0.2-4/m². The connector 10 after the zinc immersion is placed in a nitrogen-protected heating furnace to be heated. The maximum temperature of the heating is about 585-615° C., and the heating time at the maximum temperature is about 1.5-10 min, which are determined by the thickness of the material. The connector 10 is cooled down after the heating. It is tested that the thickness of the diffusion layer obtained after the heating is about 20-100 μm, and the mass concentration of zinc of the diffusion layer is about 0.3-2%.

The connection tube 40 made of copper is placed into the connection hole 31 of the above connector 10, the Al—Cu—Si—Zn based brazing filler metal is selected, the oxygen acetylene flame is adopted for heating, the brazing is performed by means of the fluoroaluminate brazing flux, and the product is obtained after the brazing.

Two ends of the above product are sealed, and then a salt spray test of an acid simulated seawater circulation (ASTM G85-A3 standard) is carried out. After 1000 hours of the salt spray test, there is no external corrosion and leakage.

In some other embodiments, the connector 10 is made of aluminum alloy. A water suspension with KZnF3 whose concentration is 15% is coated on the outer peripheral surface of the connector body 30. A mass of coated KZnF3 per unit area is about 5-60 g/m². The connector 10 after the coating is placed in a heating furnace to be heated (the connector 10 may be put into the furnace together with the core of the heat exchanger or may be put into the furnace separately). The maximum temperature of the heating is about 585-615° C., and the heating time at the maximum temperature is about 1.5-10 min. The connector 10 is cooled down after the heating. It is tested that the thickness of the diffusion layer obtained after the heating is about 20-150 μm, and the mass concentration of zinc of the diffusion layer is about 1-10%.

The connection tube 40 made of copper is placed into the connection hole 31 of the connector 10, the Al—Cu—Si—Ni based brazing filler metal is selected, the oxygen acetylene flame is adopted for heating, the brazing is performed by means of the fluoroaluminate brazing flux, and the product is obtained after the brazing.

Two ends of the above product are sealed, and then a salt spray test of an acid simulated seawater circulation (ASTM G85-A3 standard) is carried out. After 1000 hours of the salt spray test, there is no external corrosion and leakage.

In some other embodiments, the connector 10 is made of aluminum alloy. After Nocolok brazing flux (insoluble brazing flux) power of 70%, binder of 15%, and Zn powder of 15% are mixed evenly, this mixture is coated on the outer peripheral surface of the connector body 30. A mass of Zn per unit area in the coated mixture is about 1-6 g/m². The connector 10 after the coating is placed in a heating furnace to be heated (the connector 10 may be put into the furnace together with the core of the heat exchanger or may be put into the furnace separately). The maximum temperature of the heating is about 585-615° C., and the heating time at the maximum temperature is about 1.5-10 min. The connector 10 is cooled down after the heating. It is tested that the thickness of the diffusion layer obtained after the heating is about 30-120 μm, and the mass concentration of zinc of the diffusion layer is about 0.5-5%.

The connection tube 40 made of copper is placed into the connection hole 31 of the above connector 10, the Al—Cu—Si based brazing filler metal is selected, the oxygen acetylene flame is adopted for heating, the brazing is performed by means of the fluoroaluminate brazing flux, and the product is obtained after the brazing.

Two ends of the above product are sealed, and then a salt spray test of an acid simulated seawater circulation (ASTM G85-A3 standard) is carried out. After 1000 hours of the salt spray test, there is no external corrosion and leakage.

In some other embodiments, the connector 10 is made of aluminum alloy. After fluoroaluminate brazing flux power of 70%, binder of 15%, and Zn-5Al powder of 15% are mixed evenly, this mixture is coated on the outer peripheral surface of the connector body 30. A mass of Zn-5Al per unit area in the coated mixture is about 1-8 g/m². The connector 10 after the coating is placed in a heating furnace to be heated. The maximum temperature of the heating is about 400-550° C., and the heating time at the maximum temperature is about 2-30 min. The connector 10 is cooled down after the heating. It is tested that the thickness of the diffusion layer obtained after the heating is about 20-200 μm, and the mass concentration of zinc of the diffusion layer is about 0.5-10%.

The connection tube 40 made of copper is placed into the connection hole 31 of the above connector 10, the Al—Cu—Si—Ni based brazing filler metal is selected, the oxygen acetylene flame is adopted for heating, the brazing is performed by means of the fluoroaluminate brazing flux, and the product is obtained after the brazing.

Two ends of the above product are sealed, and then a salt spray test of an acid simulated seawater circulation (ASTM G85-A3 standard) is carried out. After 1000 hours of the salt spray test, there is no external corrosion and leakage.

In some other embodiments, the connector 10 is made of aluminum alloy. A Zn-2Al alloy is sprayed on the outer peripheral surface of the connector body 30 by means of electric arc spraying. A sprayed mass per unit area is about 3-20 g/m². The connector 10 after the zinc spraying is placed in a nitrogen-protected heating furnace to be heated. The maximum temperature of the heating is about 340-375° C., and the heating time at the maximum temperature is about 1-3 h. The connector 10 is cooled down after the heating. It is tested that the thickness of the diffusion layer obtained after the heating is about 50-200 μm, and the mass concentration of zinc of the diffusion layer is about 1-20%.

The connection tube 40 made of copper is placed into the connection hole 31 of the above connector 10, the Al—Si based brazing filler metal is selected, the oxygen acetylene flame is adopted for heating, the brazing is performed by means of the fluoroaluminate brazing flux, and the product is obtained after the brazing.

Two ends of the above product are sealed, and then a salt spray test of an acid simulated seawater circulation (ASTM G85-A3 standard) is carried out. After 1000 hours of the salt spray test, there is no external corrosion and leakage.

In some other embodiments, the connector 10 is made of aluminum alloy. A water suspension with KZnF3 whose concentration is 20% is coated on the outer peripheral surface of the connector body 30. A mass of coated KZnF3 per unit area is about 10-60 g/m². The connector 10 after the coating is placed in a heating furnace to be heated (the connector 10 may be put into the furnace together with the core of the heat exchanger or may be put into the furnace separately). The maximum temperature of the heating is about 585-615° C., and the heating time at the maximum temperature is about 2-10 min. The connector 10 is cooled down after the heating. It is tested that the thickness of the diffusion layer obtained after the heating is about 50-150 μm, and the mass concentration of zinc of the diffusion layer is about 1-5%.

The connection tube 40 made of copper is placed into the connection hole 31 of the above connector 10, the Al—Cu—Si based brazing filler metal is selected, the oxygen acetylene flame is adopted for heating, the brazing is performed by means of the fluoroaluminate brazing flux, and the product is obtained after the brazing.

Two ends of the above product are sealed, and then a salt spray test of an acid simulated seawater circulation (ASTM G85-A3 standard) is carried out. After 1000 hours of the salt spray test, there is no external corrosion and leakage.

An internal corrosion test (ASTM D2570 standard) is carried out on an inner wall of a channel formed by the above product, and there is no internal corrosion and leakage after 21 days of the internal corrosion test.

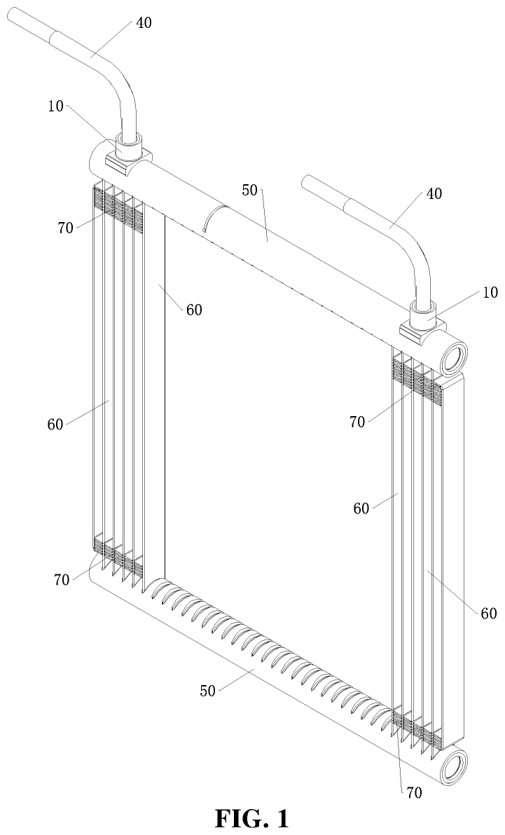

The heat exchanger according to the embodiments of the present disclosure is described below. As illustrated in FIG. 1, the heat exchanger according to the embodiments of the present disclosure includes a header 50 and the above connection structure of the heat exchanger.

The connector 10 is connected with the header 50, and the connection tube 40 is communicated with the header 50 through the connector 10, and the connection tube 40 is mainly a refrigerant inlet tube or a refrigerant outlet tube.

A manufacturing method of a heat exchanger according to the embodiments of the present disclosure includes the above welding method of the connector and the connection tube of the heat exchanger.

The heat exchanger and the manufacturing method thereof according to the embodiments of the present disclosure have the advantages of a good anti-corrosion effect, a high production efficiency and a low production cost.

Following examples are taken to describe the manufacturing method of the heat exchanger according to the embodiments of the present disclosure.

In some embodiments, the header connection couple 20 of the connector 10 is spot-welded on the header 50.

The core of the heat exchanger is assembled.

The zinc-contained coating is attached to a required position.

The connector 10 and the core of the heat exchanger are put into the furnace as a whole to complete the welding of the core of the heat exchanger, and forming the diffusion layer on the connector 10.

The core of the heat exchanger is taken out of the furnace.

The connection tube 40 is welded onto the connector 10 by adopting one of the Al—Si, Al—Cu—Si, Al—Cu—Si—Zn and Al—Si—Cu—Ni brazing filler metals.

In some other embodiments, the connector 10 is provided with zinc by electric arc spraying or chemical immersion.

The header connection couple 20 of the connector 10 is spot-welded on the header 50.

A heat exchange tube 60, a fin 70 and the header 50 are assembled.

The assembled core of the heat exchanger is bundled and fixed.

The connector 10 and the core of the heat exchanger are put into the furnace as a whole to complete the welding of the core of the heat exchanger, and forming the diffusion layer on the connector 10.

The core of the heat exchanger is taken out of the furnace.

The connection tube 40 is welded onto the connector 10 by adopting one of the Al—Si, Al—Cu—Si, Al—Cu—Si—Zn and Al—Si—Cu—Ni brazing filler metals.

In some other embodiments, the connector 10 is provided with zinc by electric arc spraying.

The connector 10 is put into the furnace separately to form the diffusion layer.

The header connection couple 20 of the connector 10 is spot-welded on the header 50.

A heat exchange tube 60, a fin 70 and the header 50 are assembled.

The assembled core of the heat exchanger is bundled and fixed.

The connector 10 and the core of the heat exchanger are put into the furnace as a whole to complete the welding of the core of the heat exchanger, and further diffuse the diffusion layer on the connector 10.

The core of the heat exchanger is taken out of the furnace.

The connection tube 40 is welded onto the connector 10 by adopting one of the Al—Si, Al—Cu—Si, Al—Cu—Si—Zn and Al—Si—Cu—Ni brazing filler metals.

In some other embodiments, the connector 10 is provided with zinc by electric arc spraying.

The connector 10 is put into the furnace separately to form the diffusion layer.

A heat exchange tube 60, a fin 70 and the header 50 are assembled.

The assembled core of the heat exchanger is bundled and fixed.

The core of the heat exchanger is put into the furnace to complete the welding of the core of the heat exchanger.

The core of the heat exchanger is taken out of the furnace.

The header connection couple 20 of the connector 10 is welded onto the header 50 by adopting the Al—Si based brazing filler metal or by adopting the fusion welding.

The connection tube 40 is welded onto the connector 10 by adopting one of the Al—Si, Al—Cu—Si, Al—Cu—Si—Zn and Al—Si—Cu—Ni brazing filler metals.

When the core of the heat exchanger is assembled in the above embodiments, the core of the heat exchanger may include the fin 70 or not, that is, the heat exchange tube 60 and the header 50 may be assembled directly. After the assembling, the core of the heat exchanger may be bundled and fixed, or may be directly welded without being bundled after being fixed by a welding device, that is, the step of bundling is omitted. The connector 10 may be put into the furnace separately to form the diffusion layer, or may be also be put into the furnace together with the assembled core of the heat exchanger, that is, the welding operation is completed, while the diffusion layer is formed.

The connector 10 for the heat exchanger according to the embodiments of the present disclosure is described below.

As illustrated in FIG. 2, the connector 10 for the heat exchanger according to the embodiments of the present disclosure includes a header connection couple 20 and a connector body 30.

The connector body 30 is arranged to the header connection couple 20, and the connector body 30 has a connection hole 31 running through the connector body 30 and the header connection couple 20 along the axial direction of the connector body 30. A diffusion layer is formed on the surface of the connector body 30, and the corrosion potential of the diffusion layer is less than the corrosion potential of the connector body 30.

A treatment method of the connector 10 of the heat exchanger according to the embodiments of the present disclosure include following steps.

A coating is attached to the surface of the connector.

The connector attached with the coating is heated so as to form the diffusion layer on the outer surface of the connector, and the corrosion potential of the diffusion layer is less than the corrosion potential of the connector.

The connector 10 of the heat exchanger and the treatment method thereof according to the embodiments of the present disclosure enable the treated connector 10 to be uneasy to corrode after being welded with the connection tube 40, and have a high production efficiency and a low cost.

Other structures and operations of the heat exchanger according to the embodiments of the present disclosure are known to those skilled in the related art, which will not be described in detail herein.

Reference throughout this specification to terms “an embodiment,” “some embodiments,” “an illustrative embodiment,” “an example,” “a specific example,” or “some examples” means that a particular feature, structure, material, or characteristic described in connection with the embodiment or example is included in at least one embodiment or example of the present application. In this specification, the appearances of the aforesaid terms are not necessarily referring to the same embodiment or example. Moreover, the particular features, structures, materials, or characteristics described may be combined in any suitable manner in one or more embodiments or examples.

Although embodiments of the present disclosure have been illustrated and described above, it should be understood by those skilled in the art that changes, modifications, alternatives, and variations may be made in the embodiments without departing from principles and purposes of the present disclosure. The scope of this disclosure is defined by the claims and their equivalents.

1. A welding method of a connector and a connection tube of a heat exchanger, comprising:
forming a diffusion layer on a surface of the connector, a corrosion potential of the diffusion layer being less than a corrosion potential of the connector;
inserting a connection tube into the connector;
brazing the connection tube to the connector by a brazing filler metal, a corrosion potential of a weld metal formed after brazing of the brazing filler metal being higher than the corrosion potential of the connector and less than a corrosion potential of the connection tube.

2. The welding method of the connector and the connection tube of the heat exchanger according to claim 1, wherein the diffusion layer is formed on at least one surface of an inner peripheral surface and an outer peripheral surface of the connector.

3. The welding method of the connector and the connection tube of the heat exchanger according to claim 1, wherein a coating is formed on a surface of the connector by means of electric arc spraying, chemical immersion plating or coating, and the coating and the connector are heated to form the diffusion layer.

4. The welding method of the connector and the connection tube of the heat exchanger according to claim 3, wherein a maximum temperature of heating is 585-615° C., and a heating time at the maximum temperature is 1.5 min-30 min.

5. The welding method of the connector and the connection tube of the heat exchanger according to claim 3, wherein a maximum temperature of heating is 330-410° C., and a heating time at the maximum temperature is 1 h-3 h.

6. The welding method of the connector and the connection tube of the heat exchanger according to claim 1, wherein the connector is an aluminum connector or an aluminum alloy connector, and the connection tube is a copper tube.

7. The welding method of the connector and the connection tube of the heat exchanger according to claim 1, wherein the diffusion layer is formed through diffusion of a coating formed on a surface of the connector, the coating contains zinc coming from a pure zinc, a zinc-contained alloy or a zinc-contained compound, and a mass of zinc per unit area of the coating is 0.2 g/m²-60 g/m².

8. The welding method of the connector and the connection tube of the heat exchanger according to claim 7, wherein a thickness of the diffusion layer is 10 μm-200 μm.

9. The welding method of the connector and the connection tube of the heat exchanger according to claim 7, wherein a mass concentration of zinc of the diffusion layer is 0.5%-20%.

10. The welding method of the connector and the connection tube of the heat exchanger according to claim 1, wherein the brazing filler metal contains a Al—Si base, a Al—Cu—Si base, a Al—Cu—Si—Zn base or a Al—Cu—Si—Ni base.

11. The welding method of the connector and the connection tube of the heat exchanger according to claim 4, wherein an aluminum alloy connector is selected, a pure zinc is sprayed on an outer peripheral surface of the connector by means of electric arc spraying, a mass of sprayed zinc per unit area is 1 g/m²-20 g/m², the connector after zinc spraying is heated under the protection of nitrogen, the maximum temperature of heating is 585° C.-615° C., the heating time at the maximum temperature is 1.5 min-10 min, so as to form the diffusion layer, the heated connector is cooled, a thickness of the diffusion layer is 10 μm-200 μm, and a mass concentration of zinc of the diffusion layer being 1%-10%;
the connection tube made of copper is inserted into the cooled connector;
the connection tube and the connector are heated by an oxygen acetylene flame, and the copper aluminum connector is brazed through the brazing filler metal and by means of a fluoroaluminate brazing flux.

12. The welding method of the connector and the connection tube of the heat exchanger according to claim 5, wherein an aluminum alloy connector is selected, a pure zinc is sprayed on an outer peripheral surface of the connector by means of electric arc spraying, a mass of sprayed zinc per unit area is 1 g/m²-20 g/m², the connector after zinc spraying is heated under the protection of nitrogen, the maximum temperature of heating is 330° C.-410° C., the heating time at the maximum temperature is 1 h-3 h, so as to form the diffusion layer, the heated connector is cooled, a thickness of the diffusion layer is 20 μm-200 μm, and a mass concentration of zinc of the diffusion layer being 1%-5%;
the connection tube made of copper is inserted into the cooled connector;
the connection tube and the connector are heated by an oxygen acetylene flame, the copper aluminum connector is brazed through the brazing filler metal and by means of a fluoroaluminate brazing flux.

13-15. (canceled)

16. A connection structure of a heat exchanger, comprising:
a connector, a diffusion layer being formed on a surface of the connector; and
a connection tube inserted into the connector and brazed with the connector through a brazing filler metal,
wherein a corrosion potential of the diffusion layer, a corrosion potential of the connector, a corrosion potential of a weld metal formed after brazing of the brazing filler metal, and a corrosion potential of the connection tube increase in sequence.

17. The connection structure of the heat exchanger according to claim 16, wherein the connector comprises:
a header connection couple; and
a connector body arranged to the header connection couple, and having a connection hole running through the connector body and the header connection couple along an axial direction of the connector body,
wherein the diffusion layer is formed on at least one surface of an inner peripheral surface and an outer peripheral surface of the connector body, the connection tube is inserted into the connection hole, and an outer peripheral surface of the connection tube is brazed with the inner peripheral surface of the connector body through a brazing filler metal.

18. The connection structure of the heat exchanger according to claim 17, wherein an end face of an end of the connector body away from the header connection couple is provided with a slope, and the slope gradually inclines to the header connection couple from outside to inside along a radial direction of the connector body.

19. The connection structure of the heat exchanger according to claim 16, wherein the connector is an aluminum connector or an aluminum alloy connector, the connection tube is a copper tube, the diffusion layer is formed through diffusion of a coating formed on a surface of the connector, and the coating contains zinc coming from a pure zinc, a zinc-contained alloy or a zinc-contained compound.

20. The connection structure of the heat exchanger according to claim 19, wherein a mass of zinc per unit area of the coating is 0.2 g/m²-60 g/m².

21. The connection structure of the heat exchanger according to claim 19, wherein a thickness of the diffusion layer is 10 μm-60 μm.

22. The connection structure of the heat exchanger according to claim 19, wherein a mass concentration of zinc of the diffusion layer is 0.5%-20%.

23. (canceled)

24. A heat exchanger, comprising:
a header; and
a connection structure of a heat exchanger, comprising:
a connector, a diffusion layer being formed on a surface of the connector; and
a connection tube inserted into the connector and brazed with the connector through a brazing filler metal,
wherein a corrosion potential of the diffusion layer, a corrosion potential of the connector, a corrosion potential of a weld metal formed after brazing of the brazing filler metal, and a corrosion potential of the connection tube increase in sequence,
wherein the connector is connected to the header, and the connection tube is communicated with the header through the connector.

25. (canceled)
